(19) United States
(12) Patent Application Publication
(10) Pub. No.: US 2004/0145668 A1
(43) Pub. Date: Jul. 29, 2004

(54) MOS solid-state imaging element and imaging device provided with the same

(75) Inventors: Takahiro Iwasawa, Nagaokakyo-shi (JP); Takumi Yamaguchi, Kyoto-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., Kadoma-shi (JP)

(21) Appl. No.: 10/760,967

(22) Filed: Jan. 20, 2004

(30) Foreign Application Priority Data
Jan. 24, 2003 (JP) 2003-016553

(51) Int. Cl. H04N 5/335

(52) U.S. Cl. 348/301

(57) ABSTRACT

It is an object of the present invention to provide a MOS solid-state imaging element having a photodiode and an amplifier for each pixel, wherein the MOS solid-state device is provided with a range specifying portion for determining a density of a signal spacing between selection signals for selecting pixels to be read out, in accordance with a range in which a resolution is to be different in an image and a resolution of the range, and a selection portion for sending the selection signals only to pixels that have been selected from among all of the pixels by outputting the selection signals in correspondence with a specification from the range specifying portion, and wherein the amplifier of a pixel to which a selection signal has been input outputs, as a pixel signal, a charge that has accumulated in the photodiode of that pixel.

### BACKGROUND OF THE INVENTION

1. Field of the Invention

The present invention relates to MOS solid-state imaging elements (MOS sensors) and imaging devices provided with MOS solid-state imaging elements (MOS sensors).

2. Description of the Related Art

In recent years there has been an increase in demand for imaging devices used in surveillance cameras, for example, that transfer or store images of required sections of captured image information at increased resolution. Standards such as JPEG2000, which is an image compression method, for meeting this demand also have been proposed.

Examples of imaging elements used in such imaging devices include MOS solid-state imaging elements (hereinafter, referred to as “MOS sensors”) and CCD solid-state imaging elements (hereinafter, referred to as “CCD sensors”). One characteristic of MOS sensors is their low power consumption, and the demand for MOS sensors is increasing due to the popularity of cameras mounted in portable telephones. CCD sensors, on the other hand, have been in use for many years. Their structure allows charge that has accumulated in photodiodes to be completely transferred, achieving low-noise images.

CCD sensors and MOS sensors have different drive methods, and as such have different operations for reading out video. CCD sensors have photodiodes and vertical CCDs for transferring charge that are paired with the photodiodes, and moreover, they have horizontal CCDs for quickly transferring charge in the horizontal direction. In CCD sensors, the charge that has accumulated in the photodiodes is read to the vertical CCDs simultaneously for all pixels, and then the charges are transferred sequentially from the vertical CCDs to horizontal CCDs and read out as video signals by an output amplifier.

MOS sensors do not have CCDs for transferring charge, and instead pixel amplifiers are provided at each photodiode. In the case of MOS sensors, charge that has accumulated in the photodiodes is converted into signal voltage by the pixel amplifiers in accordance with instructions by vertical selection signals and horizontal selection signals, and this signal voltage is sent to an output amplifier and read out as a video signal.

In both CCD sensors and MOS sensors, it is necessary that all charge that has accumulated in the photodiode corresponding to a pixel is read out when outputting a signal.

A more specific example of an imaging device that employs a conventional CCD sensor and that allows variability in the resolution in any region of the image information is described next. First the configuration of the CCD sensor is described. FIG. 6 is a block diagram of a CCD sensor in a conventional imaging device. A CCD sensor 600 has pixels 610 arranged in a matrix, and for each pixel 610 there are provided a photodiode 601 and a vertical CCD 602, which is for transferring charge, that is disposed in a pair with that photodiode 601. The CCD sensor 600 is also provided with horizontal CCDs 603 and an output amplifier 604 that outputs, as a current output, the signals obtained as the charges transferred by the vertical CCDs 602 and the horizontal CCDs 603.

The operation of the CCD sensor 600 is described next. When the imaging device captures an object, the light of the captured object that is incident through optical means such as a lens is photoelectrically converted into a signal charge by the photodiodes 601, which are for performing photoelectrical conversion. The vertical CCDs 602 are driven by a vertical CCD drive signal 608 that is input from a vertical CCD drive signal input terminal 606, and the signal charges that have accumulated in the photodiodes 601 are read out to the vertical CCDs 602. The signal charges that are read to the vertical CCDs 602 are transferred sequentially to the horizontal CCDs 603 due to the vertical CCD drive signal 608. The horizontal CCDs 603, which are driven by a horizontal CCD drive signal 609 that is input from a horizontal CCD drive signal input terminal 607, quickly send the signal charges that have been read out to the output amplifier 604. The signal charges are converted into CCD signals 611, which are current outputs, by the output amplifier 604, and these are read out from a signal output terminal 605.

The operation of an imaging device provided with the CCD sensor 600 is described next using FIG. 6 and FIG. 7. FIG. 7 is a block diagram of a conventional imaging device. A timing generation portion 703 generates the horizontal CCD drive signal 609 and the vertical CCD drive signal 608 shown in FIG. 6, and inputs these to the CCD sensor 600 from the horizontal CCD drive signal input terminal 607 and the vertical CCD drive signal input terminal 606. The charge signals that are accumulated in the photodiodes 601 are sequentially output from the CCD sensor 600 via the signal output terminal 605 as CCD signals 611 in accordance with the vertical CCD drive signal 608 and the horizontal CCD drive signal 609, and are transmitted to a signal processing portion 702. At the signal processing portion 702 the CCD drive signals 611 are subjected to general image signal processing, such as color separation, white balance processing, gamma correction, aperture processing, gain control processing, and offset control processing, creating multivalue signals.

The signals for a single picture that have been created are recorded in a memory 705 via a memory control portion 706. To change the resolution of a region of the signal for a single picture, the region and its resolution are set in the timing generation portion 703 in advance. The timing generation portion 703 specifies the region and its resolution to the memory control portion 706. Based on this, the memory control portion 706 filters portions to be read out at lower resolution, reducing the data amount. As for portions that are to be read out at increased resolution, signals that are read from the CCD sensor 600 are output as they are. These signals are output from the signal output terminal 704, and thus an image with different resolutions for desired regions in a single picture is obtained.

In addition to the above description, an imaging element having multiple resolution capabilities is disclosed in Tokuhyo 2002-507863. This imaging element is capable of creating multiple resolutions and allows the signal to noise ratio to be adjusted. With respect to its ability to create multiple resolution signals, it is provided on-chip so as to achieve high-speed imaging, and employs improved pixel binning having total differential circuits disposed so that all unrelated noise and noise that is picked up is removed.

To obtain an image having a plurality of resolutions in a single picture with conventional configurations, however, it is necessary first to read out all pixel signals from the imaging element and then to store at least the signals of a single picture in a memory. This necessarily requires memories with large capacities.

Also, the upper limit of the operation frequency of image elements is limited by the frequency properties of the output amplifier and the frequency properties of the horizontal drive signal, and thus when there are many pixels it takes time to read out all of the pixel signals, resulting in the problem that it is necessary to reduce the frame rate at which images can be captured.

The present invention was developed in light of the above matters, and it is an object thereof to provide a MOS solid-state imaging element which has a small memory and with which it is possible to output images with different resolutions in desired regions without lowering the frame rate, and also to provide an imaging device provided with this MOS solid-state imaging element.

### SUMMARY OF THE INVENTION

A MOS solid-state imaging element has a photodiode and an amplifier for each pixel, and comprises a range specifying portion for determining a density of a signal spacing between selection signals for selecting pixels to be read out, in accordance with a range in which the resolution is to be different in an image and a resolution of the range, and a selection portion for sending the selection signals only to pixels that have been selected from among all of the pixels by outputting the selection signals corresponding to a specification from the range specifying portion. The amplifier of a pixel to which a selection signal has been input outputs, as a pixel signal, a charge that has accumulated in the photodiode of that pixel.

### BRIEF DESCRIPTION OF THE DRAWINGS

FIG. 1 is a block diagram of a MOS sensor of an imaging device according to a first embodiment of the present invention.

FIG. 2 is a timing chart of the selection signals of the MOS sensor according to the first embodiment of the present invention.

FIG. 3 is an explanatory diagram showing the relationship between the pixels and the timing chart of the horizontal selection signals and the vertical selection signals of the pixels of the MOS sensor according the first embodiment of the present invention.

FIG. 4 is a block diagram of the imaging device according to the first embodiment of the present invention.

FIG. 5 is an explanatory diagram showing the relationship between the pixels and the timing chart of the horizontal selection signals and the vertical selection signals of the pixels of the MOS sensor according the second embodiment of the present invention.

FIG. 6 is a block diagram of a CCD sensor in a conventional imaging device.

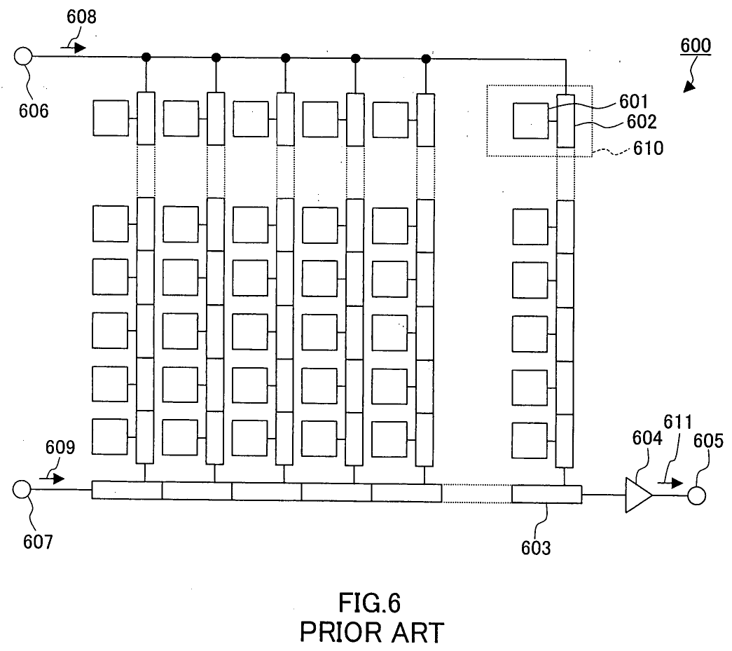

FIG. 7 is a block diagram of a conventional imaging device.

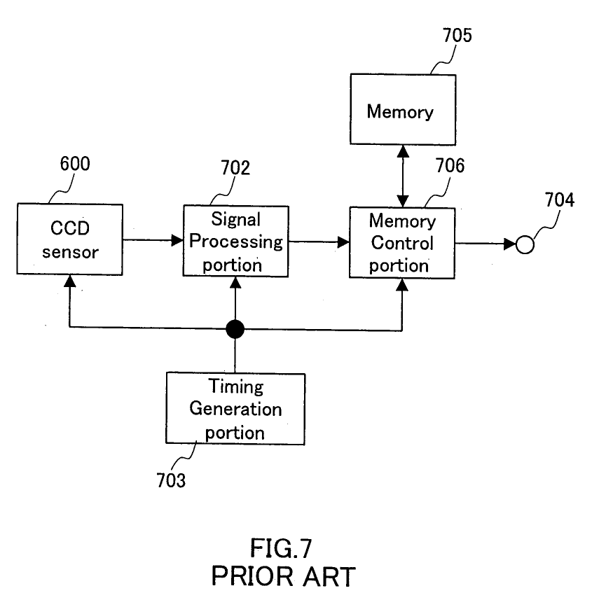

### DESCRIPTION OF THE PREFERRED EMBODIMENTS

As regards the MOS solid-state imaging element of this embodiment, a signal spacing between selection signals is changed to alter the number of pixels to be read out so as to read out an image having regions with different resolutions in a single picture, and thus the number of pixel signals that are output is less than the total number of pixels. Thus, as regards the imaging device, it is not necessary to provide as many memories as there are pixels, the memories can be made with a small capacity, and it is not necessary to lower the frame rate. It is also possible for the imaging device to have a configuration in which it does not include memories.

Also, it is preferable that the MOS solid-state imaging element is further provided with a memory portion storing in advance a range in which a resolution is to be different in the image and the resolution of that range. Thus, it is easy to achieve the circuit of the range specifying portion, and this allows the circuit to be simplified. It is therefore possible to reduce the chip size and achieve a reduction in costs.

It is also preferable that the range in which a resolution is to be different in the image and a resolution of the range, which are specified by the range specifying portion, are dynamically changed from the outside. Thus, the element is effective in a case where a region in which the resolution is to be different moves within the picture. For example, a person may be moving in the picture, and the region with a different resolution can be changed actively to correspond to this movement. Thus, if the element is used in a surveillance camera or the like then it can be employed effectively for person identification.

It is also preferable that the element further includes a color filter for each pixel. Thus, the number of pixels that are read out can be reduced even for pixel signals having a color component, and thus as regards the imaging device, it is not necessary to dispose as many memories as there are pixels, the memories can be made with a small capacity, and it is not necessary to lower the frame rate. It is also possible for the imaging device to have a configuration in which it does not include memories.

It is also preferable that in a region with lowered resolution among all of the pixels, pixel signals having an identical color component are mixed or averaged and then output. Thus, by performing pixel mixing or averaging within the MOS sensor for regions in which the resolution is lowered, it is possible to achieve signals for which spatial LPF has been executed, obtaining a good image in which aliasing noise has been reduced.

It is also possible that when outputting image signals, information expressing a range in which a resolution is to be different in the image and a resolution of the range are added to the image signals before they are output to the outside.

An imaging device according to this embodiment is provided with the MOS solid-state imaging element discussed above. Thus, the density of the signal spacing between selection signals can be changed to alter the number of pixels to be read out, so as to read out an image having regions with different resolutions in a single picture. Therefore, the number of pixel signals that are output is less than the total number of pixels, it is not necessary to dispose as many memories as there are pixels, the memories can be made with a small capacity, and it is not necessary to lower the frame rate. It is also possible for the imaging device to have a configuration in which it does not include memories.

It is also preferable that the imaging device of this embodiment is provided with the MOS solid-state imaging element described above and a filter portion that executes filter processing with respect to image signals output from the MOS solid-state imaging element at a boundary between regions having different resolutions, and that the filter portion changes a tap coefficient in conjunction with the spacing of the density in accordance with the information added to the image signals. Thus, it is possible to achieve an image in which image distortion due to noncontiguous frequency properties, which occurs in regions whose resolution has been switched, in the image has been smoothed out.

A specific embodiment of the present invention is described below with reference to the drawings.

First Embodiment

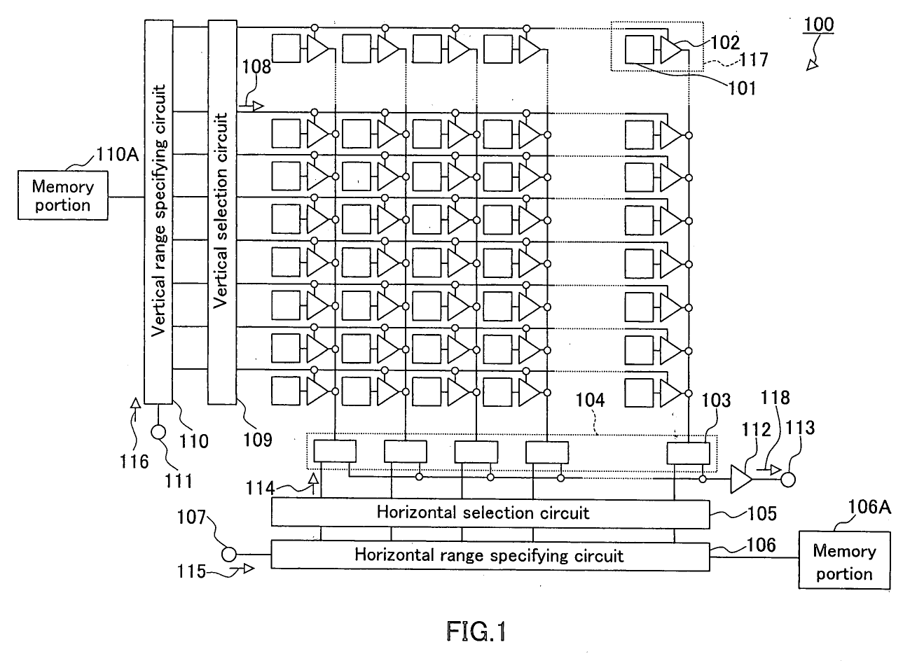

A MOS solid-state imaging element and an imaging device provided with this MOS solid-state imaging element according to a first embodiment of the present invention are described below. FIG. 1 is a block diagram of a MOS sensor 100 of an imaging device according to the first embodiment.

The MOS sensor 100 is provided with photodiodes 101, pixel amplifiers 102, horizontal read portions 103, a horizontal selection switching circuit 104, a horizontal selection circuit 105, a horizontal range specifying circuit 106, a horizontal range specifying input signal terminal 107, a vertical selection circuit 109, a vertical range specifying circuit 110, a vertical range specifying input signal terminal 111, an output amplifier 112, and a signal output terminal 113.

A photodiode 101 and a pixel amplifier 102 forming a pair with that photodiode 101 are provided for each pixel 117, which are disposed in a matrix. The photodiodes 101 photoelectrically convert light obtained from an object to be captured through optical means (not shown) such as a lens. The pixel amplifiers 102 convert the charge that is accumulated through photoelectrical conversion by the photodiodes 101 into a pixel signal.

A horizontal read portion 103 is provided for each column of pixels 117. Each horizontal read portion 103 is connected to an entire column of pixel amplifiers 102, and reads the pixel signals from the pixels 117, which are arranged in columns. The horizontal selection switching circuit 104 is for switching the pixel signals read from the pixels 117, which are arranged in columns, between the columns.

The horizontal selection circuit 105 outputs a horizontal selection signal 114 for selecting, for each column, the pixel signal of pixels to be read out. The horizontal selection signal 114 is delivered to the horizontal read portions 103.

The horizontal range specifying circuit 106 determines the density of the signal spacing of the horizontal selection signals 114 based on a horizontal range specifying signal 115 that is input from the horizontal range specifying signal input terminal 107, and indicates the result to the horizontal selection circuit 105. The horizontal range specifying signal 115 is a signal for specifying the range in which a resolution is to be different in the horizontal direction in the image, and the resolution of this range. The density of the signal spacing of the horizontal selection signals 114 is necessary for the horizontal selection circuit 105 to create the horizontal selection signals 114.

The vertical selection circuit 109 is connected to each row of pixels 117. The vertical selection circuit 109 outputs a vertical selection signal 108 for selecting the pixel signals of pixels to be read out for each row, and sends it to the pixel amplifiers 102 of each row.

The vertical range specifying circuit 110 determines the density of the signal spacing of the vertical selection signals 108 based on a vertical range specifying signal 116 that is input from the vertical range specifying signal input terminal 111, and indicates the result to the vertical selection circuit 109. The vertical range specifying signal 116 is a signal for specifying the range in which a resolution is to be different in the vertical direction in the image, and the resolution of this range. The signal spacing density of the vertical selection signals 108 is necessary for the vertical selection circuit 109 to create the vertical selection signals 108.

The output amplifier 112 is for reading the pixel signals as MOS sensor signals 118 (image signals), and the MOS sensor signals 118 are output from the signal output terminal 113.

The operation of the MOS sensor 100 is described next. First, the light of an object to be captured is converted into electricity, and of the signal charges that have accumulated in the photodiodes 101, the pixel signals of pixels to be read out that have been selected by the vertical selection signals 108 and the horizontal selection signals 114 are read out as MOS sensor signals 118 from the output amplifier 112 via the horizontal read portions 103, and are output from the signal output terminal 113.

When selecting pixels to be read out, a range in which the resolution is to be different in the image and the resolution of that range are input to the vertical range specifying circuit 110 and the horizontal range specifying circuit 106 by the vertical range specifying signal 116 and the horizontal range specifying signal 115. Based on these signals, the vertical range specifying circuit 110 and the horizontal range specifying circuit 106 specify the extent of the density of the signal spacing of the vertical selection signals 108 and the horizontal selection signals 114 to the vertical selection circuit 109 and the horizontal selection circuit 105. The vertical selection signals 108 and the horizontal selection signals 114 are output by the vertical selection circuit 109 and the horizontal selection circuit 105, respectively, making it possible to select pixels to be read.

For example, in the case of pixel signals of a region for which the resolution can be low, pixels are selected and read out at every other pixel, as opposed to reading out every pixel, in at least one of the row direction and the column direction. That is, in regions where the resolution is low, the pixel signals are read out with some of the pixels being eliminated. In regions requiring high resolution, however, the pixel signal of every pixel in that region can be read out. Doing this allows the amount of data of the MOS sensor signals 118 that are output from the MOS sensor 100 to be made smaller than the total pixel amount of a single picture, and thus this data amount can be stored in a small-capacity memory.

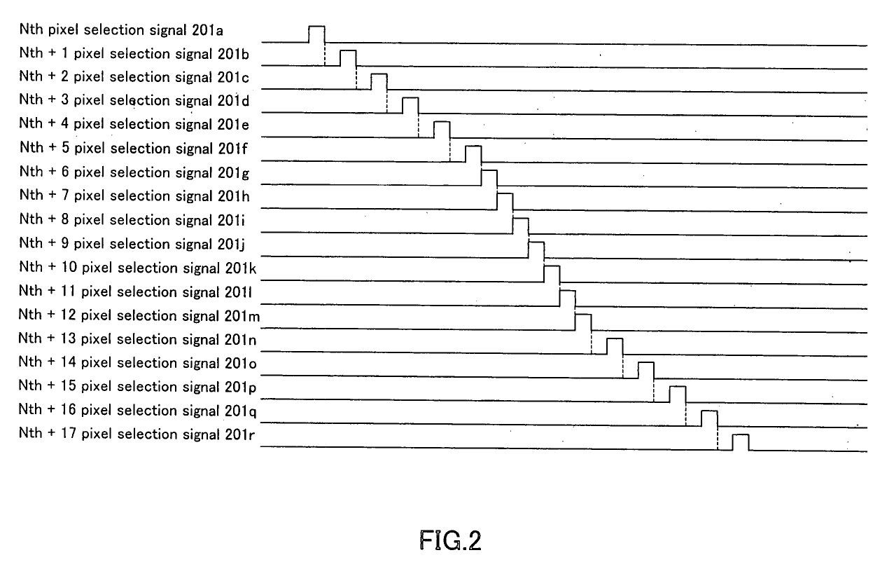

FIG. 2 shows a timing chart of the selection signals of the MOS sensor 100 according to the first embodiment. A specific timing chart of the selection signals is described below using FIG. 2. It should be noted that the only difference between vertical selection signals and horizontal selection signals is whether they are for the columns or the rows of the image, and thus the timing chart for them is the same. The timing chart of FIG. 2 is a timing chart of selection signals in a case where an Nth number pixel at any location in the image of a single picture is taken as an origin, and there are regions in which the number of pixels to read out is halved to lower the resolution, and a region in which all of the pixels are read out so that the resolution is full resolution. It should be noted that N is a natural number. The pixels are read out in sequence from the Nth pixel to the Nth+17 pixel. In FIG. 2, the horizontal axis is the time axis. That is, signals are output sequentially in the order of the selection signals 201a to 201r. The selection signals 201a to 201f in the region where the pixels are read out at (the resolution of) half of their number are not input continuously but rather with a pause of one pulse between them and the next signal. On the other hand, the selection signals 201g to 201m of the region where pixels are read out at full resolution are input continuously without a pause between them. Also, the selection signals 201n to 201r are for a region in which the pixels once again are read out at half resolution, and thus in the same manner as the selection signals 201a to 201f, they are input with a space of one pulse between them and the next signal.

Although the pixel signals of pixels for which a selection signal is received are output, there is a space of one pulse between the selection signal 201a and the selection signal 201b, for example, and thus the pixel signal of the pixel that is adjacent to the pixel that was output due to the selection signal 201a is not output, and the pixel signal of the pixel that is adjacent to that pixel is then output due to the selection signal 201b. In this manner, the number of pixels is reduced to half, reducing the resolution of this region to one half. It should be noted that the selection signals 201g to 201m are input without a space between them, and thus there is no drop in resolution because the pixel signals of adjacent pixels are output in succession.

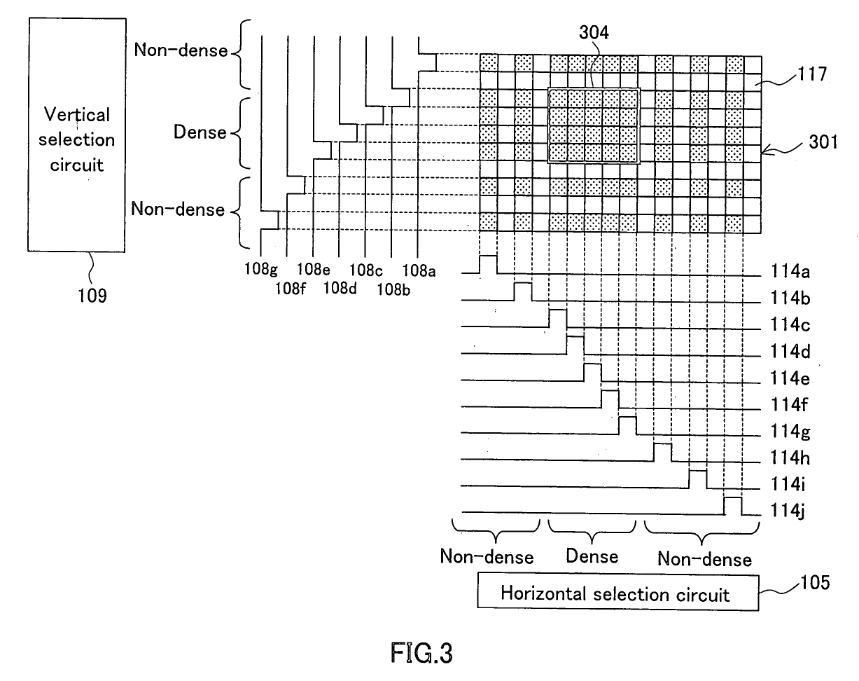

Next, in a more specific explanation, both the horizontal selection signals and the vertical selection signals will be considered. FIG. 3 is an explanatory diagram showing the relationship between the pixels 117 and the timing chart of the horizontal selection signals and the vertical selection signals of the pixels 117 of the MOS sensor 100 according to the first embodiment. In FIG. 3, the vertical selection signals 108a to 108g and the horizontal selection signals 114a to 114j are input to the pixel amplifiers from the vertical selection circuit 109 and the horizontal selection circuit 105, and pixel signals are output from the pixels 117 that receive these selection signals.

The horizontal selection signal 114a is input, and then after a pause of one pulse, the horizontal selection signal 114b is input. Next, the horizontal selection signal 114c to the horizontal selection signal 114g are input in succession, and then, after a pause of one pulse after the horizontal selection signal 114g is input, the horizontal selection signal 114h is input. Also, the vertical selection signal 108a is input, and then after a pause of one pulse, the vertical selection signal 108b is input, after which the vertical selection signals are input in succession up to the vertical selection signal 108e, and then, after a pause of one pulse after the vertical selection signal 108e is input, the vertical selection signal 108f is input, and then after a pause of one pulse, the vertical selection signal 108g is input. In this manner, the pixels to be read out are selected by the vertical selection signals 108a to 108g and the horizontal selection signals 114a to 114j. By creating areas of high and low density of the pixels 117 to be read out, a pixel portion 301 comes to have different resolutions in its various regions.

The pixel portion 301 of the MOS sensor is constituted by the pixels 117 arranged in rows. The rows are selected by the input of the vertical selection signals 108a to 108g and the columns are selected by the input of the horizontal selection signals 114a to 114j, and pixel signals are output from the pixels 117 corresponding to these inputs. Of the pixels 117, the pixels 117 to which shading has been added in FIG. 3 output pixel signals, and all other pixels 117 do not output a pixel signal. In a region 304, all of the pixels have been selected and output their pixel signals. In other regions, however, the resolution has been halved because the number of pixels has been reduced to half. In this manner, all of the pixel signals of the region 304 and the pixel signals of the other regions, the number of which has been halved, are output from the output amplifier as video signals. At this time, information expressing areas of high and low density of the vertical selection signals 108a to 108g and the horizontal selection signals 114a to 114j can be added to the MOS sensor signals 118 (FIG. 1) as header information. This allows the device receiving the image information to produce a display or the like that effectively utilizes the information on the signal density.

The region 304 can be changed dynamically depending on the object whose image is being captured. For example, the region 304 can be moved automatically to correspond to the movement of a person to be captured.

Also, although the region 304 is rectangular in the first embodiment, it can also be set to a region enclosed by a curved line, and region designation such as pen input or template input also can be employed. Although the frequency component of the vertical selection signals 108a to 108g and the horizontal selection signals 114a to 114j was altered to change the resolution, it is also possible to combine this with an application such as digitization (black/white display), color conversion, and designating display and non-display regions.

It should be noted that in the regions with lowered resolution, pixels to be read out were selected at every other row or column, but it is also possible to select pixels to be read out at every two or more rows or columns, and by doing so the resolution can be reduced to less than half of the original resolution.

It should be noted that the range of the high and low density of pixels and its extent can be fixed, and for example, the horizontal range specifying circuit 106 and the vertical range specifying circuit 110 can be provided with memory portions 106A and 110A (FIG. 1), respectively, to store the range of the signal density and the extent thereof. This makes it possible to simplify the circuit configuration, allowing costs to be reduced.

It is also possible to allow the range of the density of the pixels and the extent thereof to be changed dynamically from the outside. For example, with a resistor in the MOS sensor 100, it is possible to change the resolution of any range freely through programming from the outside.

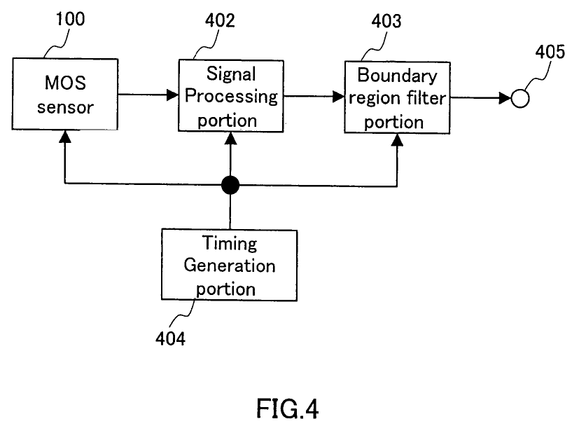

An imaging device according to the first embodiment, which is provided with the MOS sensor 100 described above, is described next. FIG. 4 is a block diagram of the imaging device according to the first embodiment.

The imaging device is provided with the MOS sensor 100, a signal processing portion 402 for subjecting the output signals that are output from the MOS sensor 100 to general image signal processing, such as color separation, white balance processing, gamma correction, aperture processing, gain control processing, and offset control processing, so as to create multivalue signals, a timing generation portion 404 for generating the drive signals for the MOS 100, a boundary region filter portion 403 for executing filter processing with respect to the boundary between regions with different resolutions, and a signal output terminal 405.

The pixel signals of boundary portions between regions with different resolutions are sent from the timing generation portion 404 to the boundary region filter portion 403 as signals, and filter processing of the boundary regions is performed with filtering properties designated in advance so that the boundary portions have smooth transitions in resolution. As for the filtering properties, there is a space filter for reducing distortion of the frequency components. The tap coefficient of the filter is changed to correspond to the degree of density of the horizontal selection signals 114 or the vertical selection signals 108 that has been added to the MOS sensor signals. That is, if the spacing between the horizontal selection signals 114 or the vertical selection signals 108 is low density, then the resolution is low, and thus the tap coefficient is adjusted so that the cutoff frequency becomes low in the frequency properties of the space filter.

Likewise, if the spacing between the horizontal selection signals 114 or the vertical selection signals 108 is high density, then the resolution is high, and thus the frequency properties of the space filter are increased. That is, the cutoff frequency is set to half of the Nyquist frequency of the input signals. Thus, the boundary between regions with different resolutions no longer stands out, and a good image can be obtained.

It should be noted that the MOS sensor of this embodiment allows the resolution to be varied in any region, but it is also possible to read the signals of all pixels without varying the resolution.

Second Embodiment

An imaging device according to a second embodiment of the present invention is described using the diagrams. The imaging device of the second embodiment has a configuration in which color filters for creating color signals are formed in the photodiodes of the MOS sensor of the imaging device of the first embodiment. Consequently, the block diagrams of the MOS sensor and the imaging device of the second embodiment are identical to those of FIG. 1 and FIG. 4.

In a case where color filters have been formed, the order of the pixel signals that are output is the same read order regardless of whether the resolution has been changed or not, and thus the resolution can be lowered by eliminating one of every two adjacent pixels or every two lines, mixing, or averaging. By reading out pixels mixing or averaging them within the MOS sensor, it is possible to obtain MOS sensor signals for which spatial LPF effects have been employed for areas that have been read out at reduced resolution. Consequently, it is possible to output a good image in which aliasing noise has been reduced.

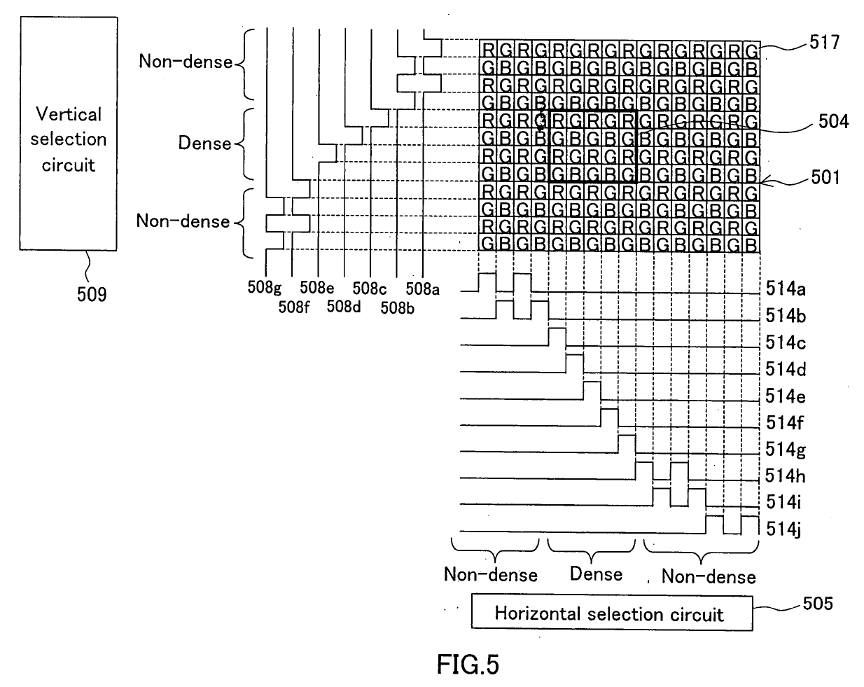

Accordingly, the operation of a case in which the signal components corresponding to color filters of an identical color that are disposed around pixels in question are mixed to change the resolution is described next using FIG. 5. FIG. 5 is an explanatory diagram showing the relationship between the pixels and the timing chart of the horizontal selection signals and the vertical selection signals for each pixel of the MOS sensor according to the second embodiment.

A pixel portion 501 of the MOS sensor is made of pixels 517 arranged in rows as shown in FIG. 5. An RGB color filter is formed in each pixel 517 as shown in FIG. 5, and creates color signals. Rows are selected by vertical selection signals 508a to 508g, which are input to the pixel amplifiers of the pixels 517 from a vertical selection circuit 509. Columns are selected by horizontal selection signals 514a to 514j, which are input to the pixel amplifiers of the pixels 517 from a horizontal selection circuit 505. Pixel signals are output from pixels 517 that correspond to these inputs.

In the case of reading the region 504 of the pixel portion 501 at increased resolution, the horizontal selection signals 514c to 514g, of the horizontal selection signals 514a to 514j, corresponding to the region 504 to be read out with increased resolution, are set to a high signal spacing density. Areas that are not included in the region 504 are read out with the resolution lowered to one half, and thus the horizontal selections signals 514a to 514b and 514h to 514j are set to a low signal spacing density. At this time, pixels of the same color component that are disposed at the periphery of the pixels in question are read out at the same time and are mixed by the pixel signal read portions.

Likewise for the vertical selection signals 508a to 508g, the vertical selection signals 508c to 508e are the selection signals for the region 504 to be read out at increased resolution, and the vertical selection signals 508a to 508b and 508f to 508g are the selection signals for reading at a resolution lowered to one half With the vertical selection signals as well, pixels in which color filters of the same color component are formed are read out simultaneously and mixed by the pixel signal read portions.

In this manner, a region to be read out at a lowered resolution can be read out mixing the pixel signals of pixels in which color filters of identical color components are formed. It is therefore possible to output a good image. It should be noted that as regards the color filters, the same applies for color filters of colors other than the primary colors RGB, such as complementary colors, so that pixel signals of pixels for which color filters of identical color components have been formed can be mixed or averaged and then read out, allowing the same effects to be attained.

It should be noted that the imaging device of the second embodiment can employ a MOS sensor having color filters as described above so as to achieve the imaging device shown in FIG. 4.

With the MOS solid-state imaging element and the imaging device provided with this element according to the present embodiment, it is possible to reduce memory capacity, so that an image with different resolutions in particular regions can be output without lowering the frame rate. The imaging device may also adopt a configuration in which it does not have a memory.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A MOS solid-state imaging element having a photodiode and an amplifier for each pixel, comprising:
a range specifying portion for determining a density of a signal spacing between selection signals for selecting pixels to be read out according to a range in which a resolution is to be different in an image and a resolution of the range; and
a selection portion for sending the selection signals only to pixels that have been selected from among all of the pixels by outputting the selection signals in correspondence with a specification from the range specifying portion;
wherein the amplifier of a pixel to which a selection signal has been input outputs, as a pixel signal, a charge that has accumulated in the photodiode of that pixel.

2. The MOS solid-state imaging element according to claim 1, further comprising:
a memory portion storing in advance a range in which a resolution is to be different in the image and a resolution of that range.

3. The MOS solid-state imaging element according to claim 1,
wherein the range in which a resolution is to be different in the image and a resolution of the range, which are specified by the range specifying portion, are dynamically changed from the outside.

4. The MOS solid-state imaging element according to claim 1, further comprising:
a color filter for each pixel.

5. The MOS solid-state imaging element according to claim 4,
wherein in a region with lowered resolution among all of the pixels, pixel signals having an identical color component are mixed or averaged and then output.

6. The MOS solid-state imaging element according to claim 1,
wherein when outputting image signals to the outside, information expressing a range in which a resolution is to be different in the image and a resolution of the range are added to the image signals before they are output.

7. An imaging device comprising:
the MOS solid-state imaging element according to claim 1.

8. An imaging device comprising the MOS solid-state imaging element according to claim 6, comprising:
a filter portion that executes filter processing with respect to the image signals output from the MOS solid-state imaging element at a boundary between regions having a different resolution;
wherein the filter portion changes a tap coefficient in conjunction with the spacing of the density in accordance with the information added to the image signals.
